(19) United States
(12) Patent Application Publication
(10) Pub. No.: US 2026/0121249 A1
(43) Pub. Date: Apr. 30, 2026

(54) SECONDARY BATTERY

(71) Applicant: Samsung SDI Co., Ltd., Yongin-si (KR)

(72) Inventor: Dong Bok YANG, Yongin-si (KR)

(21) Appl. No.: 19/008,410

(22) Filed: Jan. 2, 2025

(30) Foreign Application Priority Data
Jul. 17, 2024 (KR) 10-2024-0094284

(51) Int. Cl. H01M 50/534; H01M 50/533

(52) U.S. Cl. CPC H01M 50/534; H01M 50/533

(57) ABSTRACT

A secondary battery includes: a case; and an electrode assembly accommodated in the case. The electrode assembly includes: a first electrode; a second electrode; and a separator. The first electrode includes an electrode tab and a lead connected to the electrode tab. At least one of the electrode tab and the lead includes a variable resistance region, and an electrical resistance of the variable resistance region is different from an electrical resistance of another region of the at least one of the electrode tab and the lead.

### CROSS-REFERENCE TO RELATED APPLICATION

The present application claims priority to and the benefit of Korean Patent Application No. 10-2024-0094284, filed on Jul. 17, 2024, in the Korean Intellectual Property Office, the entire disclosure of which is incorporated herein by reference.

### BACKGROUND

### 1. Field

Embodiments relate to a secondary battery.

### 2. Description of the Related Art

Different from primary batteries, which are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly including (or composed of) a positive electrode and a negative electrode, a case accommodating the same, and electrode terminals connected to the electrode assembly.

The information disclosed in this section is provided for enhancement of understanding of the background of the present disclosure, and therefore, it may contain information that does not form the prior art.

### SUMMARY

Embodiments of the present disclosure provide a secondary battery having improved safety.

A secondary battery, according to an embodiment of the present disclosure, includes a case and an electrode assembly accommodated in the case. The electrode assembly includes a first electrode, a second electrode, and a separator. The first electrode includes an electrode tab and a lead connected to the electrode tab. At least one of the electrode tab and the lead has a resistance variable region, and an electrical resistance of the resistance variable region is different from an electrical resistance of another region of the at least one of the electrode tab and the lead.

The lead may have a first region and a second region. The electrical resistances of the first region and the second region may be different from each other, and the first region may include the resistance variable region.

The first region may include a first metal and a second metal, the second region may include the first metal, and the first metal and the second metal may include at least one of aluminum, copper, nickel, and an alloy thereof.

A length of the first region may be smaller than a total length of the second region.

The length of the first region may be in a range of 0.5% to 1% of a total length of the lead.

The case may include an accommodation part and a cap part. The accommodation part and the cap part may be coupled by a sealing layer, and the first region may overlap the sealing layer.

The first region may have a 1-1 region and a 1-2 region.

A length of the 1-1 region may be longer than a length of the 1-2 region.

An electrical resistance of the 1-1 region and an electrical resistance of the 1-2 region may be different from each other.

The 1-1 region may include a first metal and a second metal, the 1-1 region may include the first metal and a third metal, and the second region may include the first metal.

The lead may have a third region between the 1-1 region and the 1-2 region, and the third region may include a fourth metal.

The electrode tab may include a first region and a second region. The electrical resistances of the first region and the second region may be different from each other, and the first region may include the variable resistance region.

The first region may include a first metal and a second metal, the second region may include the first metal, and the first metal and the second metal may include at least one of aluminum, copper, nickel, and an alloy thereof.

A length of the first region may be in a range of 0.5% to 1% of a total length of the electrode tab.

The first region may have a 1-1 region and a 1-2 region.

The electrical resistance of the 1-1 region and the electrical resistance of the 1-2 region may be different from each other.

The lead may include a first variable resistance region, and the electrode tab may include a second variable resistance region.

The length of the first resistance variable region and the length of the second resistance variable region may be different from each other.

### BRIEF DESCRIPTION OF THE DRAWINGS

The accompanying drawings, which are incorporated in this specification, illustrate embodiments and further illustrate aspects and features of the present disclosure in conjunction with the detailed description of embodiments that follows.

The present disclosure is not to be construed as limited to what is shown in such drawings, in which:

FIG. 1 is a perspective view of a secondary battery according to an embodiment.

FIGS. 2a and 2b are top views showing a lead of the secondary battery shown in FIG. 1.

FIG. 3 is a top view of the secondary battery shown in FIG. 1.

FIG. 4 is a cross-sectional view taken along the line A-A′ in FIG. 3.

FIG. 5 is a top view of a lead of the secondary battery according to an embodiment.

FIGS. 6 and 7 are cross-sectional views taken along the line B-B′ in FIG. 5 according to various embodiments.

FIGS. 8a-8c are views illustrating the overlapping of the lead of the secondary battery and a sealing layer and the insulating layer according to various embodiments.

FIG. 9 is a top view of the lead of the secondary battery according to an embodiment.

FIGS. 10 to 12 are cross-sectional views taken along the line C-C′ in FIG. 9 according to various embodiments.

FIG. 13 is a top view of an electrode tab of the secondary battery according to another embodiment.

FIGS. 14 and 15 are cross-sectional views taken along the line D-D′ in FIG. 13 according to various embodiments.

FIG. 16 is a top view of the electrode tab of the secondary battery according to another embodiment.

FIGS. 17 to 19 are cross-sectional views taken along the line E-E′ section in FIG. 16.

FIG. 20 is a top view of the electrode tab and the lead of the secondary battery according to another embodiment.

FIG. 21 is a cross-sectional view taken along the line F-F′ in FIG. 20.

FIGS. 22 and 23 are views showing secondary batteries having different shapes incorporating embodiments of the present disclosure.

FIG. 24 is a perspective view of a battery module including secondary batteries incorporating embodiments of the present disclosure.

FIGS. 25 and 26 are perspective views showing a battery pack including battery modules according to some embodiments.

FIGS. 27 and 28 are a perspective view and a side view showing a vehicle including battery packs according to some embodiments.

### DETAILED DESCRIPTION

Hereinafter, embodiments of the present disclosure will be described, in detail, with reference to the accompanying drawings. The terms or words used in the present specification and claims are not to be narrowly interpreted according to their general or dictionary meanings but should be interpreted as having meanings and explaining concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some embodiments of the present disclosure and do not represent all of the technical spirit, aspects, and features of the present disclosure. Accordingly, it should be understood that there may be various equivalents and modifications that can replace or modify embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S. C. § 112(a) and 35 U.S. C. § 132(a).

References to two compared elements, features, etc. as being “the same” may mean that they are “substantially the same”. Thus, the phrase “substantially the same” may include a case having a deviation that is considered low in the art, for example, a deviation of about 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

Hereinafter, a secondary battery according to embodiments of the present disclosure will be described with reference to the drawings. A secondary battery may be classified based on it having a cylindrical shape, a prismatic shape, a pouch shape, or a coin shape. Aspects and features of the embodiments of the present disclosure described below may be applied to a pouch secondary battery, a cylindrical secondary battery, or a prismatic secondary battery. Hereinafter, the pouch secondary battery is primarily described, but the present disclosure is not limited thereto.

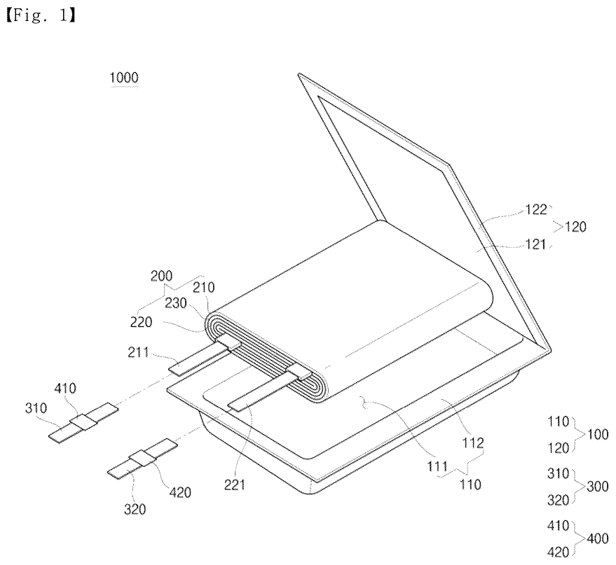

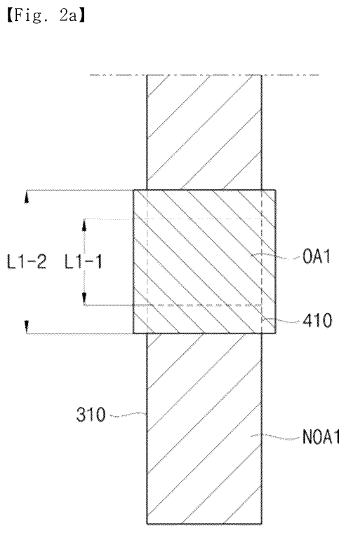

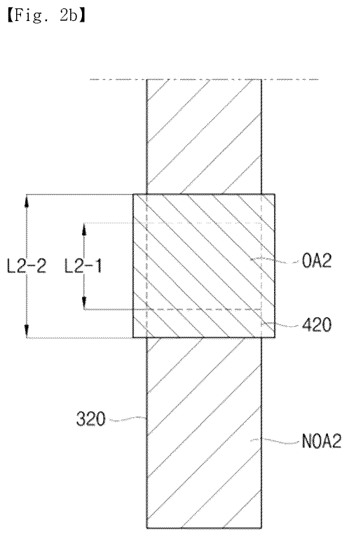

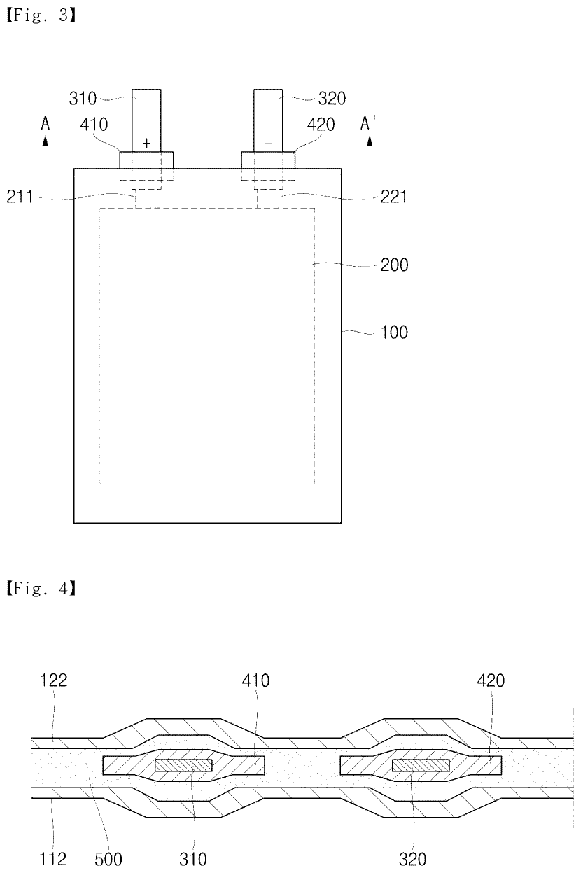

Referring to FIGS. 1 to 4, a secondary battery 1000, according to an embodiment, may include a case 100 and an electrode assembly 200.

The case 100 may include an accommodation part 110 and a cap part 120. The accommodation part 110 and the cap part 120 may be connected to each other. The case 100 may be formed in (or may have) a pouch shape.

The accommodation part 110 may have a concave part 111 and a first sealing region 112. The accommodation part 110 may form an accommodation space. For example, the accommodation part 110 may have an internal bottom surface and an inner side surface formed by the concave part 111. The accommodation space may be formed by the bottom surface and the inner side surface.

The first sealing region 112 may be disposed at the edge of the accommodation part 110. A sealing layer may be disposed on the first sealing region 112.

The cap part 120 may have a cover part 121 and a second sealing region 122.

The cover part 121 may cover the accommodation part 110. For example, the cover part 121 may cover the electrode assembly 200 accommodated in the accommodation part 110.

The second sealing region 122 may be disposed at the edge of the cap part 120. The sealing layer may be disposed on the second sealing region 122. The first sealing region 112 and the second sealing region 122 may overlap each other. For example, when the accommodation part 110 is covered by the cap part 120, the first sealing region 112 and the second sealing region 122 may face each other.

The electrode assembly 200 may be accommodated in the case 100. For example, the electrode assembly 200 may be accommodated inside the accommodation space of the case. For example, the electrode assembly 200 may be accommodated inside the accommodation space together with an electrolyte.

In the drawing, an embodiment in which one electrode assembly is accommodated in the case is illustrated. However, the present disclosure is not limited thereto, and in other embodiments, two or more electrode assemblies may be accommodated in the case.

The electrode assembly 200 may include a first electrode 210, a second electrode 220, and a separator 230. The electrode assembly 200 may be formed by winding or laminating the first electrode 210, the second electrode 220, and the separator 230. When the electrode assembly 200 has a winding shape (e.g., is a wound electrode assembly), the winding axis may be parallel to a Y axis direction. In another embodiment, the electrode assembly may be a Z-stack electrode assembly in which the first electrode 210 and the second electrode 220 are inserted on both sides of a separator 230, which is bent (or folded) into a Z-stack.

The first electrode 210 may include a first electrode current collector and a first electrode active material layer. The first electrode current collector may include a metal foil, such as aluminum or an aluminum alloy. The first electrode active material layer may include a transition metal oxide. For example, the first electrode 210 may be a positive electrode.

The first electrode 210 may include a first electrode tab 211. The first electrode active material layer is not disposed on the first electrode tab 211. The first electrode tab 211 may be welded to the first electrode current collector. In another embodiment, the first electrode tab 211 may be formed integrally with the first electrode current collector. For example, the first electrode current collector may have a first uncoated portion at where the first electrode active material layer is not disposed. The first uncoated portion may be the first electrode tab 211. The first electrode tab 211 may include (or may be formed of) the same material as the first electrode current collector.

The second electrode 220 may include a second electrode current collector and a second electrode active material layer. The second electrode current collector may include a metal foil, such as copper, a copper alloy, nickel, or a nickel alloy. The second electrode active material layer may include graphite or carbon. For example, the second electrode 220 may be a negative electrode.

The second electrode 220 may include a second electrode tab 221. The second electrode active material layer is not disposed on the second electrode tab 221. The second electrode tab 221 may be welded to the second electrode current collector. In another embodiment, the second electrode tab 221 may be formed integrally with the second electrode current collector. For example, the second electrode current collector may have a second uncoated portion at where the second electrode active material layer is not disposed. The second uncoated portion may be the second electrode tab 221. The second electrode tab 221 may include (or may be formed of) the same material as the second electrode current collector.

The first electrode tab 211 and the second electrode tab 221 may each be connected to a lead. For example, the first electrode tab 211 may be connected to the first lead 310. The first electrode tab 211 may be connected to the first external terminal by the first lead 310. The second electrode tab 221 may be connected to the second lead 320. The second electrode tab 221 may be connected to the second external terminal by the second lead 320. The first lead 310 may include the same material as the first electrode tab, and the second lead 320 may include the same material as the second electrode tab.

The first lead 310 may have a first overlapping area OA1 and a first non-overlapping area NOA1. The first overlapping area OA1 may have a 1-1 length L1-1. The first overlapping area OA1 may overlap with the case 100. For example, the first overlapping area OA1 may overlap with the first sealing region 112 and the second sealing region 122. The first non-overlapping area NOA1 does not overlap with (e.g., is offset from) the first sealing region 112 and the second sealing region 122.

A first insulating layer 410 may be disposed on the first lead 310. For example, the first insulating layer 410 may be disposed on the first overlapping area OA1. The first insulating layer 410 may surround (e.g., may extend around or may wrap around) the first lead 310. For example, the first insulating layer 410 may be disposed on the upper surface, lower surface, and side surfaces of the first lead 310 at the first overlapping area OA1.

The first insulating layer 410 may be disposed with a 1-2 length L1-2. The 1-2 length L1-2 may be longer than the 1-1 length L1-1. That is, the first insulating layer 410 may be disposed at the first overlapping area OA1 and a portion of the first non-overlapping area NOA1. Accordingly, the first insulating layer 410 may be disposed while covering the entire first overlapping area OA1.

Therefore, the first lead 310 may be insulated from the case 100 by the first insulating layer 410, and the first lead 310 and the case 100, which include different materials from each other, may be easily coupled by the first insulating layer 410. That is, the first insulating layer 410 may be a buffer layer or an adhesive layer.

The second lead 320 may have a second overlapping area OA2 and a second non-overlapping area NOA2. The second overlapping area OA2 may have a 2-1 length L2-1. The second overlapping area OA2 may overlap with the case 100.

For example, the second overlapping area OA2 may overlap with the first sealing region 112 and the second sealing region 122. The second non-overlapping area NOA2 does not overlap with (e.g., is offset from) the first sealing region 112 and the second sealing region 122.

A second insulating layer 420 may be disposed on the second lead 320. For example, the second insulating layer 420 may be disposed at the second overlapping area OA2. The second insulating layer 420 may surround (e.g., may extend around or may wrap around) the second lead 320. For example, the second insulating layer 420 may be disposed on the upper surface, lower surface, and side surfaces of the second lead 320 at the second overlapping area OA2.

The second insulating layer 420 may be disposed with a 2-2 length L2-2. The 2-2 length L2-2 may be longer than the 2-1 length L2-1. That is, the second insulating layer 420 may be disposed at the second overlapping area OA2 and a portion of the second non-overlapping area NOA2. Accordingly, the second insulating layer 420 may be disposed to cover the entire second overlapping area OA2.

Therefore, the second lead 320 may be insulated from the case 100 by the second insulating layer 420, and, the second lead 320 and the case 100, which include different materials from each other, may be easily coupled by the second insulating layer 420. That is, the second insulating layer 420 may be a buffer layer or an adhesive layer.

The secondary battery may flow a current exceeding the allowable current range due to overcharge or malfunction. The current is transmitted to the electrode assembly along the lead and the electrode tab. Accordingly, the electrode assembly may be heated (e.g., may be excessively heated) by the overcurrent. Accordingly, the internal temperature of the secondary battery may increase. If the electrode assembly is exposed to a high-temperature environment for a long time, the electrolyte may vaporize and generate gas, and the internal pressure of the secondary battery may increase due to the gas. Accordingly, a fire may occur in the secondary battery.

Embodiments of the present disclosure may avoid a fire by changing the material of the lead.

The description of the lead described below may be applied to at least one of the first lead 310 and the second lead 320 as described above.

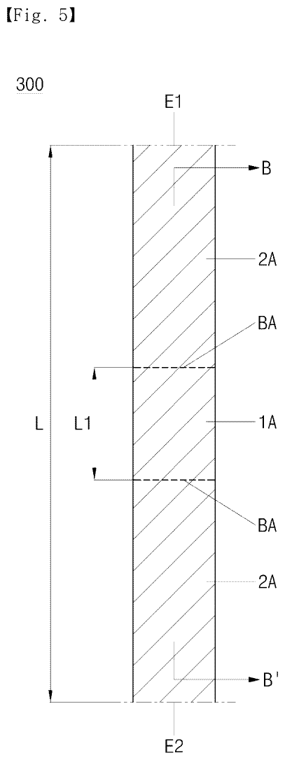

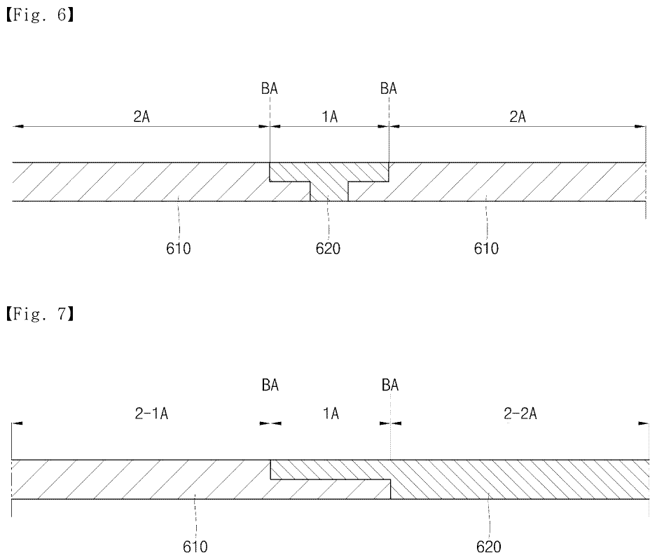

FIGS. 5 and 6 are top views of the lead according to an embodiment.

Referring to FIGS. 5 and 6, the lead 300 may have a plurality of regions. For example, the lead 300 may have a first region 1A and a second region 2A.

The first region 1A may be formed in one region of the lead 300. For example, the lead 300 may have a first end E1 and a second end E2. The first end E1 may be connected to an external terminal. The second end E2 may be connected to the electrode tab.

The first region 1A may be disposed between the first end E1 and the second end E2. For example, the first region 1A may be disposed between two second regions 2A.

The size of the first region 1A may be smaller than the size of the second region 2A.

The lead 300 may include a conductive material. For example, the lead 300 may include a metal. For example, the lead 300 may include at least one of aluminum (Al), nickel (Ni), copper (Cu), and an alloy thereof.

Referring to FIGS. 6 and 7, the first region 1A and the second region 2A may include different metals.

Referring to FIG. 6, the first region 1A may include a plurality of metals. For example, the first region 1A may include a first metal 610 and a second metal 620. The second region 2A may include one metal (e.g., may include only one metal). For example, the second region 2A may include (e.g., may only include or may be composed of) the first metal 610.

For example, the first lead 310 may include a first metal including aluminum and a second metal having an electrical resistance different from that of the first metal. The second lead 320 may include a first metal including nickel and a second metal having an electrical resistance different from that of the first metal.

Referring to FIG. 7, the first region 1A may include a plurality of metals. For example, the first region 1A may include a first metal 610 and a second metal 620.

The second region may include a plurality of regions. For example, the second region may include a 2-1 region 2-1A and a 2-2 region 2-2A. The 2-1 region 2-1A and the 2-2 region 2-2A may include one metal. For example, the 2-1 region 2-1A may include the first metal 610. The 2-2 region 2-2A may include the second metal 620.

For example, the first lead 310 may include a first metal including aluminum and a second metal having a different electrical resistance from the first metal. The second lead 320 may include a first metal including nickel and a second metal having a different electrical resistance from the first metal.

The first metal 610 and the second metal 620 may be (or may include) different metals. Metals have unique electrical resistances depending on their types. Accordingly, the electrical resistances of the regions may vary depending on the types of metals.

For example, referring to FIG. 6, the first region 1A has a first electrical resistance, and the second region 2A has a second electrical resistance. The first region 1A includes two different metals. Accordingly, the first electrical resistance and the second electrical resistance may be different from each other.

Referring to FIG. 7, the first region 1A has a first electrical resistance, the 2-1 region 2-1A has a 2-1 electrical resistance, and the 2-2 region 2-2A has a 2-2 electrical resistance. The first region 1A includes two different metals, and the 2-1 region 2-1A and the 2-2 region 2-2A include different metals. Accordingly, the first electrical resistance, the 2-1 electrical resistance, and the 2-2 electrical resistance may be different from each other.

The lead 300 may include a region in which the electrical resistance changes while extending from the first end E1 to the second end E2. For example, the lead 300 may have boundary areas BA. The first area 1A and the second area 2A are separated by boundary areas BA. That is, the first area 1A may be an area between the boundary areas BA. The electrical resistance of the lead 300 may change in the boundary areas BA. That is, the first area 1A may be an area in which the resistance changes. That is, the first area 1A may be a variable resistance area of the lead 300.

Accordingly, an overcurrent may be blocked from being transmitted to the electrode assembly. For example, when the overcurrent flows from the outside to the secondary battery, the lead may be short-circuited by the first area. The first region is a region at where the resistance changes. Accordingly, when the overcurrent flows through the electrode tab, the first region is instantly heated by the resistance of the lead due to the overcurrent.

Accordingly, the lead may be cut off (e.g., melted or separated) in the first region. Accordingly, the overcurrent may be blocked from being transmitted to the electrode assembly. Accordingly, the heating of the electrode assembly may be prevented. Accordingly, a fire of the secondary battery may be prevented. Accordingly, the secondary battery according to embodiments of the present disclosure may exhibit improved safety.

The sizes of the first region 1A and the second region 2A may be different from each other. For example, the lengths of the first region 1A and the second region 2A may be different from each other. The first region 1A may have a first length L1.

The second region 2A may have a second length. The first length L1 may be smaller than the second length. For example, the first length L1 may be smaller than the sum of the second lengths.

For example, the first length L1 may be about 1% or less of the length (e.g., the total or overall length) L of the lead 300. For example, the first length L1 may be in a range of about 0.5% to about 1%, about 0.6% to about 0.9%, or about 0.7% to about 0.8% of the length L of the lead 300.

If the first length L1 exceeds about 1% of the length L of the lead 300, the strength of the lead 300 may decrease. Accordingly, the lead 300 may be broken during the process of welding the lead 300. If the first length L1 is less than about 0.5% of the length L of the lead 300, the size of the first region 1A decreases. Accordingly, when the overcurrent flows through the lead 300, the lead 300 may not be broken (e.g., may not melt). Accordingly, the overcurrent may be transmitted to the electrode assembly, causing the fire in the secondary battery.

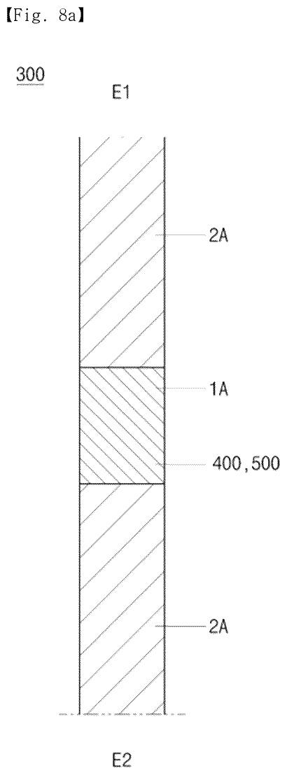

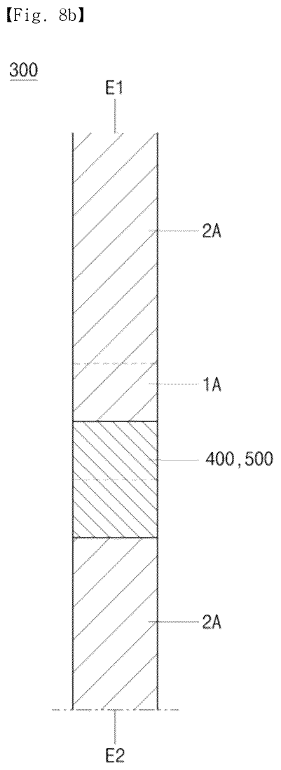

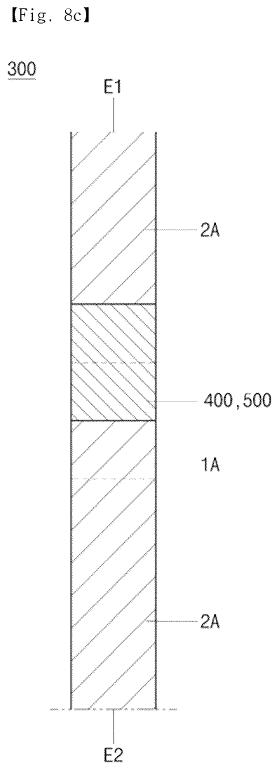

Referring to FIGS. 8a-8c, the first region 1A may be disposed at a set region. For example, the first region 1A may entirely or partially overlap the sealing layer 500. The sealing layer 500 is disposed between the first sealing region 112 and the second sealing region 122 of the case 100. The first region 1A may entirely or partially overlap the insulating layer 400. For example, the insulating layer 400 may be disposed between the first region 1A and the sealing layer 500.

Referring to FIG. 8a, the first region 1A may entirely overlap the sealing layer 500. Referring to FIGS. 8b and 8c, the first region 1A may partially overlap the sealing layer 500.

For example, referring to FIG. 8b, a portion of the first region 1A may overlap the sealing layer 500, another portion thereof may not overlap the sealing layer 500, and another portion of the first region 1A may be disposed outside the case 100.

Referring to FIG. 8c, a portion of the first region 1A may overlap the sealing layer 500, another portion thereof may not overlap the sealing layer 500, and another portion of the first region 1A may be disposed inside the case 100.

The first region includes a plurality of metals. For example, the first region includes a plurality of metals coupled to each other. For example, the plurality of metals may be coupled by welding or an adhesive layer. Accordingly, the strength of the first region may be lower than the strength of the second region. Accordingly, the lead may be damaged at the first region by an external impact. Accordingly, a defect in the secondary battery may occur when the secondary battery is normally operated. Because the first region overlaps the sealing layer and/or the insulating layer, the first region may be fixed by the sealing layer and/or the insulating layer. Accordingly, the first region may not be damaged by an external impact. Therefore, the reliability of the secondary battery may be improved.

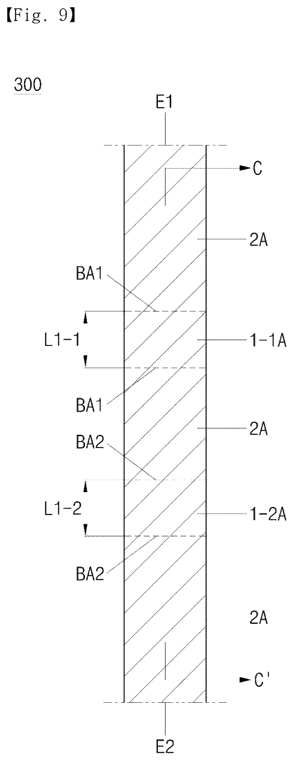

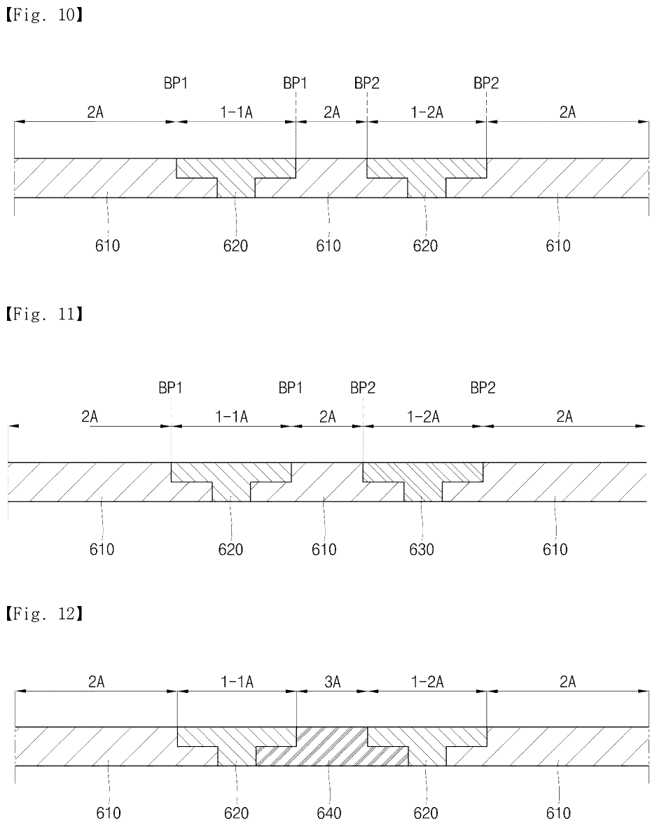

Referring to FIGS. 9 to 12, the first region 1A may include a plurality of regions. For example, the first region 1A may include a 1-1 region 1-1A and a 1-2 region 1-2A.

The 1-1 region 1-1A and the 1-2 region 1-2A may include a plurality of metals. For example, the 1-1 region 1-1A and the 1-2 region 1-2A may include the first metal 610 and the second metal 620, and the second region 2A may include (e.g., may include only) one metal. For example, the second region 2A may include (e.g., may only include) the first metal 610.

Accordingly, the lead 300 may have a region in which the electrical resistance changes while extending from the first end E1 to the second end E2. For example, the lead 300 may have a first boundary area BA1 and a second boundary area BA2. The 1-1 region 1-1A and the second region 2A may be divided by the first boundary areas BA1, and the 1-2 region 1-2A and the second region 2A may be divided by the second boundary areas BA2. The electrical resistance of the lead 300 may change in the first boundary area BA1 and the second boundary area BA2. That is, the 1-1 region 1-1A and the 1-2 region 1-2A may be regions at where the resistance changes. That is, the 1-1 region 1-1A and the 1-2 region 1-2A may be variable resistance regions of the lead 300.

Therefore, an overcurrent may be blocked from being transmitted to the electrode assembly. For example, when the overcurrent flows from the outside to the secondary battery, the lead may be short-circuited by the 1-1 region or the 1-2 region. Accordingly, the lead may be cut off (e.g., melted) in the 1-1 region or the 1-2 region. That is, the lead may include at least two variable resistance regions. Accordingly, even if one variable resistance region is defective, the lead may be short-circuited at another variable resistance region.

Therefore, an overcurrent may be blocked from being transmitted to the electrode assembly. Accordingly, the heating of the electrode assembly may be prevented. Accordingly, the fire of the secondary battery may be prevented. Accordingly, the secondary battery according to an embodiment may have improved safety.

The lengths of the 1-1 region 1-1A and the 1-2 region 1-2A may be the same as each other or different from each other. For example, the 1-1 region 1-1A may have the 1-1 length L1-1, and the 1-2 region 1-2A may have the 1-2 length L1-2.

The 1-1 length L1-1 and the 1-2 length L1-2 may be the same as each other.

In another embodiment, the 1-1 length L1-1 and the 1-2 length L1-2 may be different from each other. For example, the 1-1 length L1-1 may be longer than the 1-2 length L1-2. Based on the direction in which the current flows, the 1-1 region 1-1A may be a main (or primary) short circuit part, and the 1-2 region 1-2A may be an auxiliary (or secondary) short circuit part. The strength of the lead may be reduced by the first region. Therefore, the length of the 1-2 region 1-2A, which is an auxiliary short circuit, may be formed relatively short. Accordingly, damage to the lead due to an external impact may be prevented or reduced.

The 1-1 region 1-1A and the 1-2 region 1-2A may include different metals from each other. The 1-1 region 1-1A and the 1-2 region 1-2A may have different electrical resistances from each other.

Referring to FIG. 11, the 1-1 region 1-1A may include the first metal 610 and the second metal 620, and the first-second region 1-2A may include the first metal 610 and a third metal 630. Because the 1-1 region 1-1A and the 1-2 region 1-2A include different metals from each other, the electrical resistances of the 1-1 region 1-1A and the 1-2 region 1-2A may be different from each other. Accordingly, the difference in electrical resistance between the 1-1 region 1-1A and the second region 2A may be different from the difference in electrical resistance between the 1-2 region 1-2A and the second region 2A.

Accordingly, the first region 1A may be short-circuited across (or in response to) a wide current range. For example, the allowable current range of the lead may be widened. For example, when the metals of the 1-1 region 1-1A and the 1-2 region 1-2A are the same, the lead may be short-circuited only when current A flows therethrough. However, when the metals of the 1-1 region 1-1A and the 1-2 region 1-2A are different, the lead includes a plurality of regions having different differences in electric resistance. Therefore, in such an embodiment, the lead may be short-circuited at current B that is less than current A (i.e., current A>current B). Accordingly, the secondary battery may be applied to various electronic devices.

Referring to FIG. 12, the lead may further include a fourth metal 640. For example, the lead 300 may include a plurality of first regions 1-1A and 1-2A, second regions 2A, and third regions 3A.

The third region 3A may be disposed between the 1-1 region 1-1A and the 1-2 region 1-2A. For example, the 1-1 region 1-1A and the 1-2 region 1-2A may be disposed between the second region 2A and the third region 3A.

The third region 3A may include the fourth metal 640. The 1-1 region 1-1A and the 1-2 region 1-2A may be easily coupled by the third region 3A. For example, the third region 3A may be a buffer region.

The bonding strength of the first metal 610 and the second metal 620 may vary depending on the type of metal(s). Accordingly, there may be restrictions on the type of metal that may be used as the lead. The lead may include the fourth metal 640 that may be easily coupled with (or bonded to) the second metal 620. Accordingly, the bonding of the 1-1 region 1-1A and the 1-2 region 1-2A may be facilitated, and various additional metals may be used as the lead.

The secondary battery according to an embodiment includes the lead connected to the external terminal and the electrode tab. The lead may include a plurality of metals. Accordingly, the lead may have different electrical resistances at various positions. The lead may include a region having varied electrical resistance. Accordingly, the lead may include a variable resistance region.

When the overcurrent flows through the lead, the variable resistance region may be heated to a higher temperature than other regions. Accordingly, the lead may be cut off in the variable resistance region. Accordingly, the lead may be short-circuited at the variable resistance region.

Therefore, the lead may be short-circuited before the overcurrent flows to the electrode assembly. Accordingly, the electrode assembly may be prevented from exploding due to the overcurrent. Accordingly, the secondary battery according to an embodiment may have improved safety.

In the above description, the lead is primarily described. However, embodiments of the present disclosure are not limited thereto.

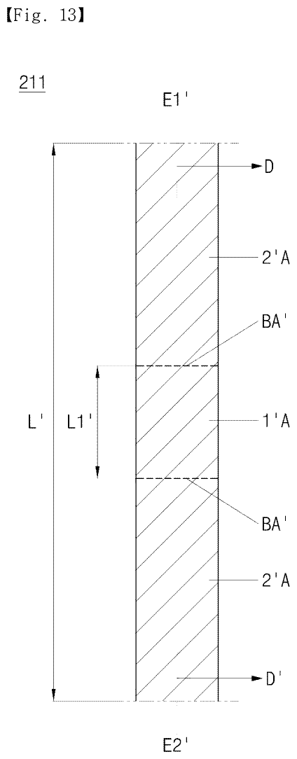

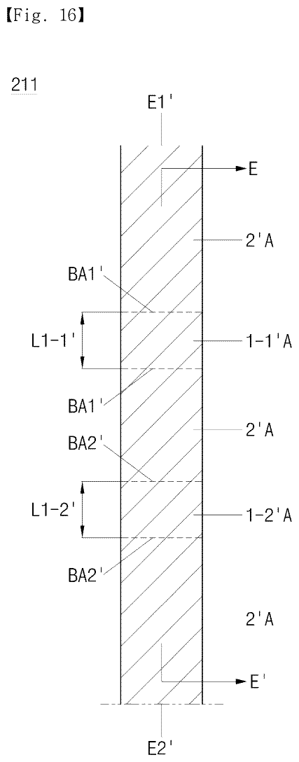

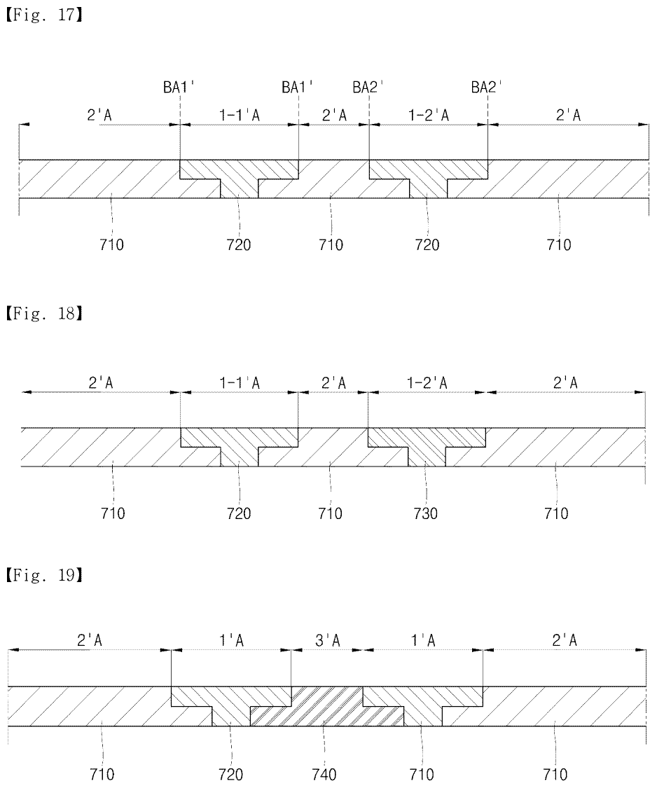

Hereinafter, a secondary battery according to another embodiment will be described with reference to FIGS. 13 to 18.

Referring to FIGS. 13 to 19, at least one of the first electrode tab 211 and the second electrode tab 221 may include a variable resistance region.

In the following description, the first electrode tab 211 is primarily described. The following description of the first electrode tab 211 may be equally applied to the second electrode tab 221.

The first electrode tab 211 may have a plurality of regions. For example, the first electrode tab 211 may have a first region 1′A and a second region 2′A.

The first region 1′A may be formed in one region of the first electrode tab. For example, the first electrode tab may have a first end E1′ and a second end E2′. The first end E1′ may be connected to the lead. The second end E2′ may be connected to the electrode assembly.

The first region 1′A may be disposed between the first end E1′ and the second end E2′. For example, the first region 1′A may be disposed between the second regions 2′A.

The size of the first region 1′A may be smaller than the size of the second region 2′A.

The first electrode tab 211 may include a conductive material. For example, the first electrode tab 211 may include a metal. For example, the first electrode tab 211 may include at least one of aluminum (Al), nickel (Ni), copper (Cu), and alloys thereof.

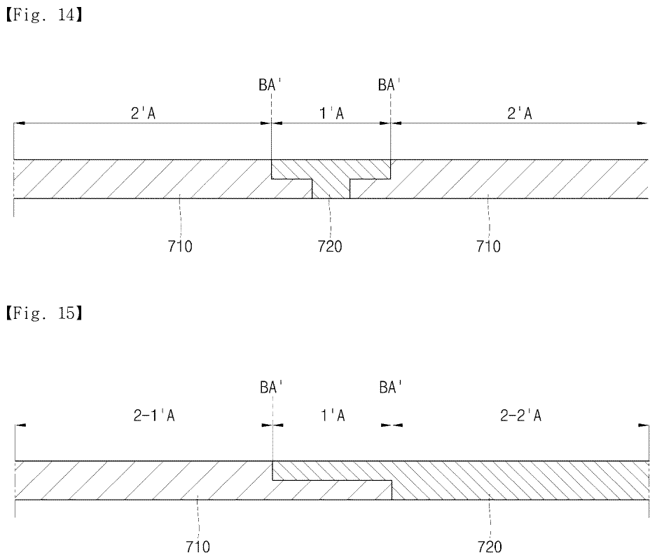

Referring to FIGS. 14 and 15, the first region 1′A and the second region 2′A may include different metals.

Referring to FIG. 14, the first region 1′A may include a plurality of metals. For example, the first region 1′A may include a first metal 710 and a second metal 720. The second region 2′A may include one metal. For example, the second region 2′A may include (e.g., may only include) the first metal 710.

For example, the first electrode tab 211 may include a first metal including aluminum and a second metal having a different electrical resistance from the first metal. The second electrode tab 221 may include a first metal including copper or nickel and a second metal having a different electrical resistance from the first metal.

Referring to FIG. 15, the first region 1′A may include a plurality of metals. For example, the first region 1′A may include a first metal 710 and a second metal 720.

The second region may have a plurality of regions. For example, the second region may include a 2-1 region 2-1′A and a 2-2 region 2-2′A. The 2-1 region 2-1′A and the 2-2 region 2-2′A may include one metal. For example, the 2-1 region 2-1′A may include the first metal 710. The 2-2 region 2-2′A may include the second metal 720.

The first metal 710 and the second metal 720 may include different metals from each other. Metals have unique electrical resistances depending on their types. Accordingly, the electrical resistances of the regions may vary depending on the types of metals.

For example, referring to FIG. 14, the first region 1′A has a first electrical resistance, and the second region 2′A has a second electrical resistance. The first region 1′A includes two different metals. Accordingly, the fist electrical resistance and the second electrical resistance may be different from each other.

Referring to FIG. 15, the first region 1A has a first electrical resistance, the 2-1 region 2-1′A has a 2-1 electrical resistance, and the 2-2 region 2-2′A has a 2-2 electrical resistance. The first region 1′A includes two different metals, and the 2-1 region 2-1′A and the 2-2′ region 2-2′A include different metals from each other. Accordingly, the first electrical resistance, the 2-1 electrical resistance, and the 2-2 electrical resistance may each be different from each other.

Therefore, the first electrode tab 211 may have a region in which the electrical resistance changes while extending from the first end E1′ to the second end E2′. For example, the first electrode tab 211 may have boundary areas BA. The first region 1′A and the second region 2′A are separated by the boundary areas BA′. For example, the first region 1′A may be a region between the boundary areas BA′. The electric resistance of the first electrode tab 211 may vary in the boundary areas BA′. The first region 1′A may be a region at where the resistance varies. That is, the first region 1′A may be a region in which the resistance varies of the first electrode tab 211.

Therefore, the overcurrent may be blocked from being transmitted to the electrode assembly. For example, when the overcurrent flows from the outside to the secondary battery, the electrode tab may be short-circuited at the first region. The first region is a region at where the resistance varies. Accordingly, when the overcurrent flows through the electrode tab, the first region is instantly heated by the resistance of the lead due to the overcurrent.

Accordingly, the lead may be cut off (e.g. melted) in the first region. Accordingly, the overcurrent may be blocked from being transmitted to the electrode assembly. Accordingly, the heating of the electrode assembly may be prevented. Accordingly, the fire of the secondary battery may be prevented. Accordingly, the secondary battery according to an embodiment may have improved safety.

The sizes of the first region 1′A and the second region 2′A may be different from each other. For example, the lengths of the first region 1′A and the second region 2′A may be different from each other. The first region 1′A may have a first length L1′. The second′ region 2′A may have a second length. The first length L1′ may be smaller than the second length. For example, the first length L1′ may be smaller than the sum of the second lengths.

For example, the first length L1′ may be about 1% or less of the length L′ of the electrode tab. For example, the first length L1′ may be in a range of about 0.5% to about 1%, about 0.6% to about 0.9%, or about 0.7% to about 0.8% of the length L′ of the electrode tab.

If the first length L1′ exceeds about 1% of the length L′ of the electrode tab, the strength of the electrode tab may decrease. Accordingly, the lead may be broken during the process of welding the lead. If the first length L1′ is less than about 0.5% of the length L′ of the electrode tab, the size of the first region decreases. Accordingly, when the overcurrent flows through the electrode tab, the electrode tab may not be broken. Accordingly, the overcurrent may be transmitted to the electrode assembly, which may cause the fire in the secondary battery.

Referring to FIGS. 16 to 19, the first region 1′A may have a plurality of regions. For example, the first region 1′A may include a 1-1 region 1-1′A and a 1-2region 1-2′A.

The 1-1 region 1-1′A and the 1-2 region 1-2′A may include a plurality of metals. For example, the 1-1 region 1-1′A and the 1-2 region 1-2′A may include the first metal 710 and the second metal 720, and the second region 2′A may include one metal. For example, the second region 2′A may include (e.g., may only include) the first metal 710.

Accordingly, the first electrode tab 211 may include a region in which the electrical resistance changes while extending from the first end E1′ to the second end E2′. For example, the first electrode tab 211 may include a first boundary area BA1′ and a second boundary area BA2′. The 1-1 region 1-1′A and the second region 2′A may be divided by the first boundary areas BA1′. The 1-2 region 1-2A′ and the second region 2′A may be divided by the second boundary areas BA2′. The electrical resistance of the first electrode tab 211 may change at the first boundary area BA1′ and the second boundary area BA2′. For example, the 1-1 region 1-1′A and the 1-2 region 1-2′A may be regions at where the resistance changes. For example, the 1-1 region 1-1′A and the 1-2 region 1-2′A may be variable resistance regions of the first electrode tab 211.

Therefore, an overcurrent may be blocked from being transmitted to the electrode assembly. For example, when overcurrent flows from the outside to the secondary battery, the electrode tab may be short-circuited by the 1-1 region or the 1-2 region. Accordingly, the electrode tab may be cut off (e.g., melted) in the 1-1 region or the 1-2 region. For example, the electrode tab may include at least two or more variable resistance regions. Accordingly, when one variable resistance region is defective, the electrode tab may be short-circuited in another variable resistance region.

Accordingly, the overcurrent may be blocked from being transmitted to the electrode assembly. Accordingly, the heating of the electrode assembly may be prevented. Accordingly, the fire of the secondary battery may be prevented. Accordingly, the secondary battery according to embodiments may have improved safety.

The lengths of the 1-1 region 1-1′A and the 1-2 region 1-2′A may be the same as each other or different from each other. For example, the 1-1 region 1-1′A may have the 1-1 length L1-1′, and the 1-2 region 1-2′A may have the 1-2 length L1-2′.

The 1-1 length L1-1′ and the 1-2 length L1-2′ may be the same as each other.

The 1-1 length L1-1 and the 1-2 length L1-2′ may be different from each other. For example, the 1-1 length L1-1′ may be longer than the 1-2 length L1-2′. Based on the direction in which the current flows, the 1-1 region 1-1′A may be a main (or primary) short-circuit part, and the 1-2 region 1-2′A may be an auxiliary (or secondary) short-circuit part. The strength of the electrode tab may be reduced by the first region. Accordingly, the length of the 1-2 region 1-2A′, which is the auxiliary short-circuit part, may be relatively short. Accordingly, damage to the electrode tab due to an external impact may be prevented or reduced.

The 1-1 region 1-1′A and the 1-2 region 1-2′A may include different metals from each other. The 1-1 region 1-1′A and the 1-2 region 1-2′A may have different electrical resistances from each other.

Referring to FIG. 18, the 1-1 region 1-1′A may include the first metal 710 and the second metal 720, and the 1-2 region 1-2′A may include first metal 710 and a third metal 730. Because the 1-1 region 1-1′A and the 1-2′ region 1-2′A include different metals from each other, the electrical resistances of the 1-1 region 1-1′A and the 1-2 region 1-2′A may be different from each other. Accordingly, the electrical resistance difference between the 1-1 region 1-1′A and the second region 2′A may be different from the electrical resistance difference between the 1-2 region 1-2′A and the second region 2′A.

Accordingly, the first region 1′A may be short-circuited across a wide current range. For example, the allowable current range of the electrode tab may be widened. For example, when the metals of the 1-1 region 1-1′A and the 1-2 region 1-2′A are the same, the electrode tab may be short-circuited only when current A flows. However, when the metals of the 1-1 region 1-1′A and the 1-2 region 1-2A′ are different from each other, the electrode tab has a plurality of regions having different differences in electric resistance. Accordingly, the electrode tab may be short-circuited in the range of current B, which is smaller than the current A (i.e., current A>current B). Accordingly, the secondary battery may be applied to various electronic devices.

Referring to FIG. 19, the electrode tab may further include a fourth metal 740. For example, the first electrode tab 211 may include a plurality of first regions 1-1′A and 1-2′A, second region 2′A, and third regions 3′A.

The third region 3′A may be disposed between the 1-1 region 1-1′A and the 1-2 region 1-2′A. For example, the 1-1 region 1-1′A and the 1-2 region 1-2′A may be disposed between the second region 2′A and the third region 3′A.

The third region 3′A may include the fourth metal 740. The 1-1 region 1-1′A and the 1-2 region 1-2′A may be easily coupled by the third region 3′A. The bonding strength of the first metal 710 and the second metal 720 may vary depending on the type of metal(s). Accordingly, there may be limitations on the type of metal(s) that may be used as the electrode tab. The electrode tab may include the fourth metal 740 that may be easily coupled with (or bonded to) the second metal 720. Accordingly, the bonding of the 1-1 region 1-1′A and the 1-2 region 1-2′A may be facilitated, and the metals that may be used as the lead may be expanded.

The secondary battery according to an embodiment includes the electrode tab connected to the lead and the electrode assembly. The electrode tab may include a plurality of metals. Accordingly, the electrode tab may have different electrical resistances depending on the position. The electrode tab may be formed with a region in which the electric resistance varies. Accordingly, the electrode tab may have a variable resistance region.

When the overcurrent flows through the electrode tab, the variable resistance region may be heated to a higher temperature than other regions.

Accordingly, the electrode tab may be cut off (e.g., melted) in the variable resistance region. Accordingly, the electrode tab may be short-circuited by the variable resistance region.

Therefore, the electrode tab may be short-circuited before the overcurrent flows to the electrode assembly. Accordingly, the electrode assembly may be prevented from exploding due to the overcurrent. Accordingly, the secondary battery according to an embodiment may have improved safety.

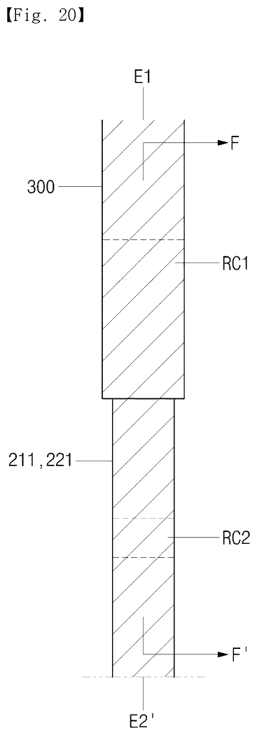

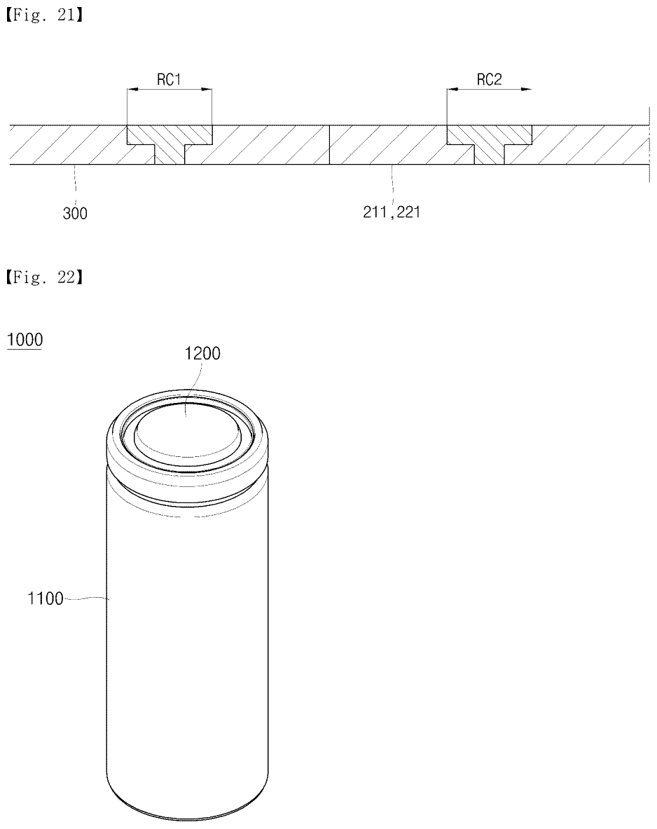

Hereinafter, a secondary battery according to another embodiment will be described with reference to FIGS. 20 and 21.

Referring to FIGS. 20 and 21, the lead 300 and one of the electrode tab 211 and 221 are coupled. For example, the second end E2 of the lead 300 may be coupled with the first end E′1 of the electrode tab 211 and/or 221.

For example, the first lead 310 and the first electrode tab 211 are coupled, and the second lead 320 and the second electrode tab 221 are coupled. For example, the lead 300 and the electrode tab 211 and 221 may be coupled by welding.

The lead 300 may have at least one first variable resistance region RC1. The electrode tabs 211 and 221 may each have at least one second variable resistance region RC2.

For example, the lead 300 and the electrode tab 211 and 221 may each have at least one variable resistance region. As described above, the variable resistance region may include a plurality of metals. Accordingly, the electrical resistance of the variable resistance region may be different from the electrical resistance of other regions. For example, the electrical resistance of the first variable resistance region RC1 may be different from the electrical resistance of other regions of the lead. The electrical resistance of the second variable resistance region RC2 may be different from the electrical resistance of other regions of the electrode tab.

As described above, the lead or the electrode tab may have a plurality of variable resistance regions. When the variable resistance regions are formed only in the lead or the electrode tab, the strength of the lead or the electrode tab may be reduced and the flow of current moving in the lead or the electrode tab may become unstable. Further, the process of forming the variable resistance region may be difficult due to space constraints.

Accordingly, the variable resistance region may be formed on both the lead and the electrode tab. Accordingly, the variable resistance region may be easily formed, and the strength of the lead and the electrode tab may not be reduced (or substantially reduced) by the variable resistance region. The current flow of the lead and the electrode tab may be prevented from becoming unstable due to the variable resistance region.

The size of the variable resistance region may be defined by length or area. The sizes of the first variable resistance region RC1 and the second variable resistance region RC2 may be the same as each other.

In another embodiment, the sizes of the first variable resistance region RC1 and the second variable resistance region RC1 may be different from each other. For example, the size of the first variable resistance region RC1 may be larger than the size of the second variable resistance region RC2.

The current moves from the lead toward the electrode tab. Accordingly, the first variable resistance region RC1 may be the main (or primary) short circuit part, and the second variable resistance region RC2 may be the auxiliary (or secondary) short circuit part.

If the size of the variable resistance region increases, the flow of current moving to the electrode assembly may become unstable. Therefore, the size of the second variable resistance region RC2, which is an auxiliary short circuit part, may be minimized. Accordingly, the flow of current moving to the electrode assembly may not become unstable due to the variable resistance region.

Therefore, when the secondary battery is operating normally, the ion exchange of the secondary battery may not be interrupted by the variable resistance region. Accordingly, the efficiency of the secondary battery may be improved.

The secondary battery according to an embodiment has a plurality of variable resistance regions. For example, the lead may include a first variable resistance region, and the electrode tab may include a second variable resistance region.

Therefore, the variable resistance region may be formed on both the lead and the electrode tab. Accordingly, the spatial constraints for forming the variable resistance region may be reduced. In addition, the strength of the lead and the electrode tab can be minimized from being reduced by the variable resistance region. In addition, the current flow of the lead and the electrode tab can be minimized from being unstable by the variable resistance region. Therefore, when the secondary battery is operating normally, the ion exchange of the secondary battery can be minimized from being interfered with by the variable resistance region. Therefore, the efficiency of the secondary battery can be improved.

Therefore, when the secondary battery is operating normally, it is possible to minimize interference of the ion exchange of the secondary battery by the variable resistance region. Therefore, efficiency of the secondary battery may be improved.

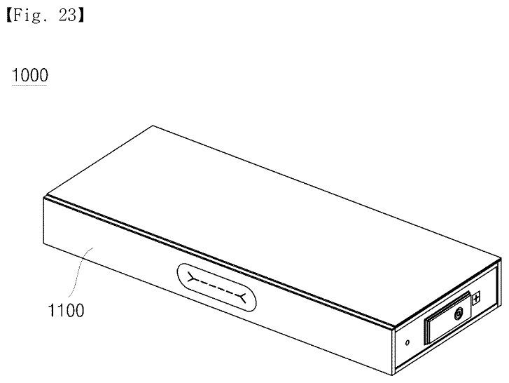

FIG. 22 and FIG. 23 are views illustrating examples of secondary batteries having different shapes including a variable resistance region.

Referring to FIG. 22 and FIG. 23, the secondary battery may be formed in various shapes.

Referring to FIG. 22, the secondary battery may include a cylindrical case 1100 and a cap plate 1200 that seals the case 1100. For example, the secondary battery may be a cylindrical secondary battery. The electrode assembly may be inserted into the case 1100 and sealed by the cap plate 1200.

The electrode assembly may be electrically connected to the case 1100 and the cap plate 1200. For example, the electrode assembly may be connected to the case 1100 through at least one of the electrode tabs and leads. The electrode assembly may be connected to the cap plate 1200 through at least one of the electrode tabs and leads as described above.

Referring to FIG. 23, the secondary battery may include a prismatic case 1100 with the electrode assembly disposed inside the case. The electrode assembly may be connected to a terminal through at least one of the electrode tabs and leads as described above. The terminal may be connected to an external terminal.

As described above, at least one of the electrode tabs and leads has a variable resistance region. Accordingly, when the overcurrent flows through the secondary battery, the variable resistance region may be short-circuited. Therefore, the fire of the secondary battery may be prevented.

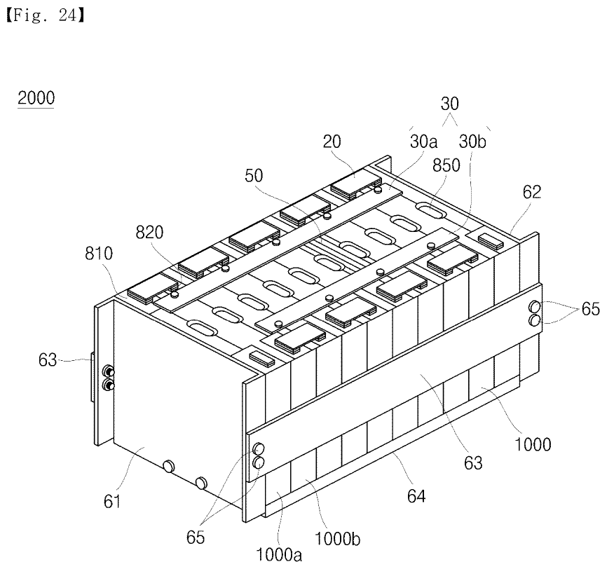

Hereinafter, a battery module including secondary batteries according to embodiments will be described with reference to FIG. 24.

Referring to FIG. 24, the battery module 2000 according to one or more example embodiments of the present disclosure includes a plurality of secondary battery 1000 arranged in one direction, a connection tab 20 connecting a secondary battery 1000a to an adjacent secondary battery 1000b, and a protection circuit module 30 having one end connected to the connection tab 20. The protection circuit module 30 may include a battery management system (BMS). Further, the connection tab 20 may have a body portion in contact with the terminal parts 810 and 820 between the adjacent secondary battery 1000a and 1000b and an extension portion extending from the body portion and connected to the protection circuit module 30. The connection tab 20 may be, for example, a bus bar.

Each secondary battery 1000 may include a battery case, an electrode assembly received (or accommodated) in the battery case, and an electrolyte. The electrode assembly and the electrolyte react electrochemically to store and release (e.g., generate) energy. Terminal parts 810 and 820 electrically connected to the connection tab 20 and a vent 850 acting as a discharge passage for gas generated inside the battery case may be provided on one side of (e.g., an upper side of) the secondary battery 1000. The terminal parts 810 and 820 of the secondary battery 1000 may be a positive electrode terminal 810 and a negative electrode terminal 820 having different polarities from each other, and the terminal parts 810 and 820 of the adjacent secondary battery 1000a and 1000b may be electrically connected to each other in series or in parallel by the connection tab 20, to be described in more detail below. Although a serial connection has been described as an example, the connection structure is not limited thereto, and various connection structures may be employed as desired. In addition, the number and arrangement of secondary battery is not limited to the structure shown in FIG. 24 and may be changed as desired.

The plurality of secondary batteries 1000 may be arranged in (e.g., may be stacked in) one direction so that the wide surfaces of the secondary batteries 1000 face each other, and the plurality of secondary batteries 1000 may be fixed by the housings 61, 62, 63, and 64. The housings 61, 62, 63, and 64 may include a pair of end plates 61 and 62 facing the wide surfaces of the secondary batteries 1000 and a side plate 63 and a bottom plate 64 connecting the pair of end plates 61 and 62 to each other. The side plate 63 may support side surfaces of the secondary batteries 1000, and the bottom plate 64 may support bottom surfaces of the secondary batteries 1000. In addition, the pair of end plates 61 and 62, the side plate 63, and the bottom plate 64 may be connected by bolts 65 and/or any other suitable fastening members and methods known to those of ordinary skill in the art.

The protection circuit module 30 may have electronic components and protection circuits mounted thereon and may be electrically connected to connection tabs 20, to be described in more detail later. The protection circuit module 30 includes a first protection circuit module 30a and a second protection circuit module 30b extending along the direction in which the plurality of secondary batteries 1000 are arranged in different locations. The first protection circuit module 30a and the second protection circuit module 30b may be spaced from each other at a suitable or desired interval (e.g., a predetermined interval) and arranged parallel to each other to be electrically connected to adjacent connection tabs 20, respectively. For example, the first protection circuit module 30a extends on one side of the upper portion of the plurality of secondary batteries 1000 along the direction in which the plurality of secondary batteries 1000 are arranged, and the second protection circuit module 30b extends to the other upper side of the plurality of secondary batteries 1000 along the direction in which the plurality of secondary batteries 1000 are arranged. The second protection circuit module 30b may be spaced from the first protection circuit module 30a at a suitable or desired interval (e.g., a predetermined interval) with the vents 850 interposed therebetween but may be disposed parallel to the first protection circuit module 30a. As such, the two protection circuit modules 30a and 30b are spaced from each other side-by-side along the direction in which the plurality of secondary batteries 1000 are arranged, thereby reducing or minimizing the area of the printed circuit board (PCB) constituting the protection circuit module 30. By separately configuring the protection circuit module into two protection circuit modules, unnecessary PCM area can be reduced or minimized. In addition, the first protection circuit module 30a and the second protection circuit module 30b may be connected to each other by a conductive connection member 50. One side of the conductive connection member 50 is connected to the first protection circuit module 30a, and the other side thereof is connected to the second protection circuit module 30b so that the two protection circuit modules 30a and 30b can be electrically connected with each other.

The connection may be performed by any one of soldering, resistance welding, laser welding, projection welding, and/or any other suitable connection methods known to those of ordinary skill in the art.

In addition, the connection member 50 may be or may include, for example, an electric wire. In addition, the connection member 50 may be made of or include a material having elasticity or flexibility. The connecting member 50 allows for the voltage, temperature, and/or current of the plurality of secondary battery 1000 to be monitored to ensure they are normal or within a desired range. For example, the information received by the first protection circuit module from connection tabs adjacent to the first protection circuit module, such as voltage, current, and/or temperature, and the information received from connection tabs adjacent to the second protection circuit module, such as voltage, current, and/or temperature, may be integrated and managed by the protection circuit module through the connection member 50.

In addition, when a secondary battery 1000 swells or receives shocks, the forces may be absorbed by the elasticity or flexibility of the connection member 50, thereby hindering or preventing the first and second protection circuit modules 30a and 30b from being damaged.

In addition, the shape and structure of the connection member 50 is not limited to the shape and structure shown in FIG. 24.

As described above, because the protection circuit module 30 is provided as the first and second protection circuit modules 30a and 30b, the area of the PCB constituting the protection circuit module can be reduced or minimized, and the space inside the battery module can be secured, which improves work efficiency by facilitating a fastening work for connecting the connection tab 20 and the protection circuit module 30 and repair work when an abnormality is detected in the battery module.

The secondary battery and battery modules according to the previously described example embodiments may be used to manufacture the battery pack.

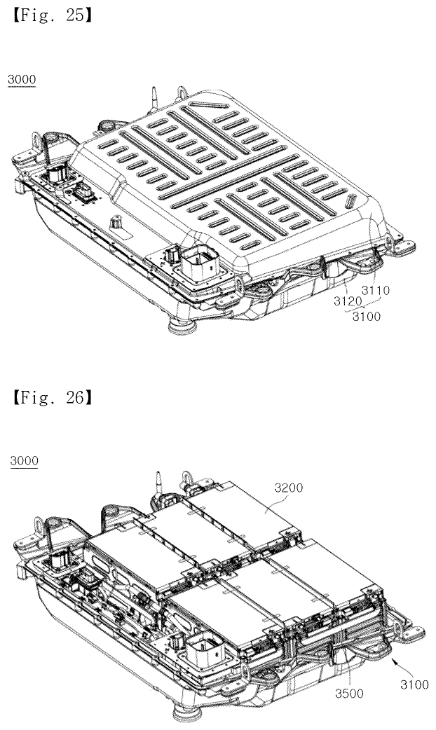

FIGS. 25 and 26 show a battery pack 3000 according to one or more example embodiments of the present disclosure. The battery pack 3000 may include a plurality of battery modules 3200 and a housing 3100 for accommodating the plurality of battery modules 3200. For example, the housing 3100 may include first and second housings 3110 and 3120 coupled in opposite directions with the plurality of battery modules 3200 therebetween. The plurality of battery modules 3200 may be electrically connected to each other by using a bus bar, and the plurality of battery modules 3200 may be electrically connected to each other in a series/parallel or series-parallel mixed method, thereby obtaining desired (e.g., required) electrical output. In the drawing, for convenience of illustration, parts such as bus bars, cooling units, and external terminals for electrical connection of secondary battery are omitted. In one or more example embodiments, battery pack 3000 may be mounted in a vehicle. The vehicle may be or may include, for example, an electric vehicle, a hybrid vehicle, or a plug-in hybrid vehicle. A vehicle may include a four-wheeled vehicle or a two-wheeled vehicle.

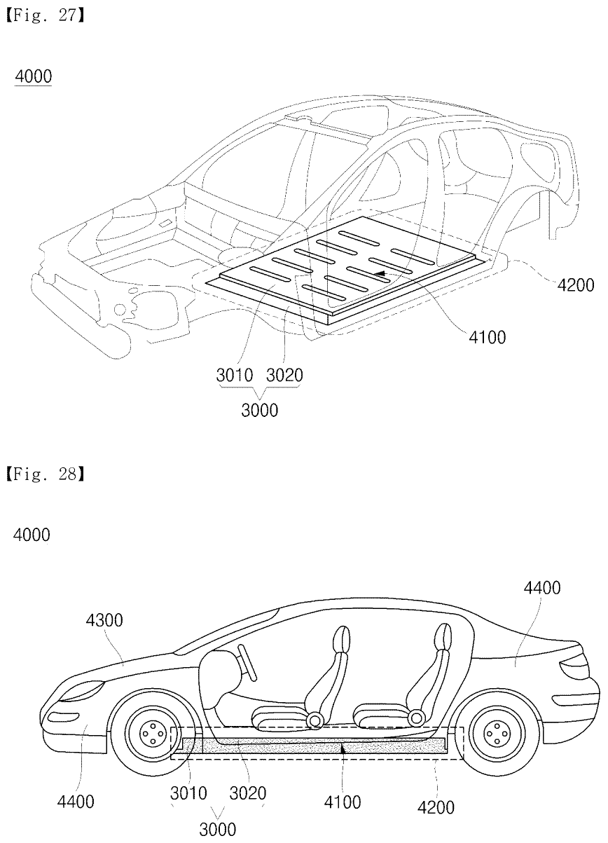

In FIG. 27, a battery pack 3000 may include a battery pack cover 3010, which is a part of a vehicle underbody 4100 and may correspond to the first housing, and a pack frame 3020, which is disposed under the vehicle underbody 4100 and may corresponding to the second housing. The battery pack cover 3010 and the pack frame 3020 may be, for example, integrally formed with a vehicle floor 4200. The vehicle underbody 4100 separates the inside and outside of a vehicle, and the pack frame 3020 may be disposed outside the vehicle

In FIG. 28, a vehicle 4000 may be formed by combining additional parts, such as a hood 4300 in front of the vehicle 4000 and fenders 4400 respectively located in the front and rear of the vehicle 4000 to a vehicle body part. The vehicle 4000 may include the battery pack 3000 including the battery pack cover 3010 and the pack frame 3020, and the battery pack 3000 may be coupled to the vehicle body part.

The above describes only some embodiments for implementing a secondary battery according to the present disclosure, the present disclosure is not limited to the above embodiments, and there is a technical spirit of the present disclosure to the extent that various modifications can be made by one having ordinary skill in the art to which the present disclosure pertains without departing from the gist of the present disclosure as claimed in the following claims and their equivalents.

What is claimed is:

1. A secondary battery comprising:
a case; and
an electrode assembly accommodated in the case, the electrode assembly comprising:
a first electrode;
a second electrode; and
a separator,
wherein the first electrode comprises an electrode tab and a lead connected to the electrode tab,
wherein at least one of the electrode tab and the lead comprises a variable resistance region, and
wherein an electrical resistance of the variable resistance region is different from an electrical resistance of another region of the at least one of the electrode tab and the lead.

2. The secondary battery as claimed in claim 1, wherein the lead has a first region and a second region,
wherein the electrical resistances of the first region and the second region are different from each other, and
wherein the first region comprises the variable resistance region.

3. The secondary battery as claimed in claim 2, wherein the first region comprises a first metal and a second metal,
wherein the second region comprises the first metal, and
wherein the first metal and the second metal comprise at least one of aluminum, copper, nickel, and an alloy thereof.

4. The secondary battery as claimed in claim 2, wherein a length of the first region is smaller than a length of the second region.

5. The secondary battery as claimed in claim 4, wherein the length of the first region is in a range of 0.5% to 1% of a total length of the lead.

6. The secondary battery as claimed in claim 2, wherein the case comprises an accommodation part and a cap part,
wherein the accommodation part and the cap part are coupled by a sealing layer, and
wherein the first region overlaps the sealing layer.

7. The secondary battery as claimed in claim 2, wherein the first region has a 1-1 region and a 1-2 region.

8. The secondary battery as claimed in claim 7, wherein a length of the 1-1 region is longer than a length of the 1-2 region.

9. The secondary battery as claimed in claim 7, wherein an electrical resistance of the 1-1 region and an electrical resistance of the 1-2 region are different from each other.

10. The secondary battery as claimed in claim 9, wherein the 1-1 region comprises a first metal and a second metal,
wherein the 1-1 region comprises the first metal and a third metal, and
wherein the second region comprises the first metal.

11. The secondary battery as claimed in claim 7, wherein the lead has a third region between the 1-1 region and the 1-2 region, and
wherein the third region comprises a fourth metal.

12. The secondary battery as claimed in claim 1, wherein the electrode tab has a first region and a second region,
wherein the electrical resistances of the first region and the second region are different from each other, and
wherein the first region comprises the variable resistance region.

13. The secondary battery as claimed in claim 12, wherein the first region comprises a first metal and a second metal,
wherein the second region comprises the first metal, and
wherein the first metal and the second metal comprise at least one of aluminum, copper, nickel, and an alloy thereof.

14. The secondary battery as claimed in claim 12, wherein a length of the first region is in a range of 0.5% to 1% of a total length of the electrode tab.

15. The secondary battery as claimed in claim 12, wherein the first region has a 1-1 region and a 1-2 region.

16. The secondary battery as claimed in claim 15, wherein the electrical resistance of the 1-1 region and the electrical resistance of the 1-2 region are different from each other.

17. The secondary battery as claimed in claim 1, wherein the lead comprises a first variable resistance region, and
wherein the electrode tab comprises a second variable resistance region.

18. The secondary battery as claimed in claim 17, wherein a length of the first variable resistance region and a length of the variable resistance region are different from each other.
